(19) United States
(12) Patent Application Publication
(10) Pub. No.: US 2024/0152849 A1
(43) Pub. Date: May 9, 2024

(54) Method For Conducting A Vulnerability Show

(71) Applicant: Keith Marz, Sherman Oaks, CA (US)

(72) Inventor: Keith Marz, Sherman Oaks, CA (US)

(21) Appl. No.: 17/983,640

(22) Filed: Nov. 9, 2022

(51) Int. Cl. G06Q 10/06; G06V 20/40

(52) U.S. Cl. CPC G06Q 10/06398; G06Q 10/06393; G06V 20/44

(57) ABSTRACT

A method for conducting a vulnerability show that is disclosed in three variations. The first variation of the show has a protagonist who visits a location and determines how prone to terrorist or other attack, or natural or man-made disaster the location is, and subsequently, how vulnerable people at the location are should a negative event occur. The second variation has at least one participant and at least one host interacting during or after a simulated terrorist or other attack, or other form of exposure that results in vulnerability, which could be an attack on a location, a hijacking or a hostage taking scenario. In the third variation instead of a terrorist or other attack, the vulnerability situation consists of a natural or man-made disaster. Some examples of these disasters include an earthquake, a fire, a tornado, a hurricane, a flood, a structure collapse or any other disaster that could occur often with little or no warning.

### TECHNICAL FIELD

The invention generally pertains to television shows, and more particularly to a show focused on vulnerability when experiencing a terrorist or other attack or a natural or man-made disaster.

### BACKGROUND ART

In the United States, as well as many other countries, one of the most popular forms of broadcast entertainment is a television show. Typically, these shows feature actors performing as characters in a drama, comedy or other situational feature, or common people doing or performing various acts such as singing, losing weight or even just living in a shared space with other people, which are commonly referred to as a reality show.

The entertaining factor results in how the people, actors or non-actors, on the show deal with or interact with various scenarios or individuals. One of the most important aspects is watching an actor or actors perform interesting/engaging jobs or actions, or seemingly ordinary/average person excel at something. Another factor is how a show character or ordinary/average person can go from a negative situation to a positive situation, and in the process improving their lives, which is known in literature as the hero's journey.

For many shows there does appear to be a template for producing the show. For example, in a reality show a group of individuals compete against each other to discover who is the best at a particular endeavor. Usually, there will be celebrity hosts or judges, as well as having the audience vote for their favorite contestant.

While this format is effective and fairly entertaining, there does appear to be a need for something new. An obvious suggestion would be to have participants and hosts would interact in some manner, and that the audience member could relate to and apply to their life. This could be accomplished by creating a situation/scenario such as a terrorist attack or disaster and having participants follow their individual decisions on how best to deal with the attack or disaster, which would coincide with the same pattern as experienced by the audience. A host could then comment on, judge and offer suggestions on how the participant reacted and the actions they took. This information would be both entertaining for the participant(s) and audience, but also educational by providing valuable information that could possibly prevent injury or save lives during an attack or disaster.

A search of the prior art did not disclose any literature or patents that read directly on the claims of the instant invention. However, the following U.S. patents are considered related:

| PATENT NO. | INVENTOR | ISSUED |
|---|---|---|
| 5,860,862 | Junkin | Jan. 19, 1999 |
| 6,439,997 | Brasseur, et al | Aug. 27, 2002 |
| 9,064,370 | Daniel | Jun. 23, 2015 |
| 2012/0274773 | Daniel, et al | Nov. 1, 2012 |

The U.S. Pat. No. 5,860,862 patent discloses an interactive apparatus and method that allows participants to compete in an interactive game based on a real time event. A visual display or audio broadcast shown or broadcast on a device of an interactive apparatus with score values indicating the players' performance in the event. Using the interactive apparatus, the participants select and trade members of a team. Information regarding the performance of the participant's team allows the participant to select and trade members that are listed in a roaster database while the event is occurring.

The U.S. Pat. No. 6,439,997 patent discloses a method for creating and providing information used in a television game show. The information is obtained from the Internet and usersregister and answer a questionnaire to create a profile. A fixed number of user profiles are randomly selected and posted on the Internet. Users then vote for their favorite user profile, and the winner is given an award, presented live during a television broadcast. Sponsors provide the award and will be given prominent advertisement.

The U.S. Pat. No. 9,064,370 patent discloses a method for conducting a sports television show. The method includes providing a cast that comprises a plurality of sports players that are undrafted, broadcasting private lives of the cast and broadcasting the cast playing at least one sports game that comprises a game without timeouts and huddles. An on-field content between the cast is accomplished by using a means for in-game contents, which includes at least one player transceiver and at least one coach transceiver for audio or visual communications to and from players, coaches, referees, or television production members.

The 2012/0274773 publication discloses a method for conducting a golf television show, comprising conducting a selection process that comprises a first component based on participants' driving range ability, oral skills, attitude and golf knowledge, and a second component based on participants' golf course performance. The selection is performed by collecting votes from viewers conducting a golf tournament, and following each participant with a camera and recording their everyday lives.

For background purposes and indicative of the art to which the invention relates, reference may be made to the following remaining patents found in the patent search.

| PATENT NO. | INVENTOR | ISSUED |
|---|---|---|
| 5,600,730 | Kenning, et al | Feb. 4, 1997 |
| 5,890,963 | Yen | Apr. 6, 1999 |
| 8,337,312 | Jones | Dec. 25, 2012 |
| 2007/0207846 | Burack, et al | Sep. 6, 2007 |
| 2008/0161113 | Hansen, et al | Jul. 3, 2008 |
| 2012/0129610 | Mazursky, et al | May 24, 2012 |

### DISCLOSURE OF THE INVENTION

A method for conducting a vulnerability show that is disclosed in three variations. The first variation of the show has a protagonist who visits a location and determines how prone to terrorist or other attack, or natural or man-made disaster the location is, and subsequently, how vulnerable people at the location are should a negative event occur. The second variation has at least one participant and at least one host interacting during or after a simulated terrorist or other attack, or other form of exposure that results in vulnerability, which could be an attack on a location, a hijacking or a hostage taking scenario. When at a location, examples of the locations could be a public space, an office, a retail store, a factory, a government facility, a private dwelling or actually any location where a single or group of terrorists or criminals could strike.

The participant(s) are preferably common people or civilians with no previous experience dealing with terrorism. The host(s), on the other hand preferably do have experience or training in terrorism situations, a person such as this could have, or previously had military, police, or other defense training.

As the participant(s) experience the simulated terrorist attack, the host(s) which, comments on and judge the participant(s) actions. The host(s) then offer suggestions and advice based on the observed participant's actings. The advice helps the participants to mitigate the dangers of the situation and possibly prevent injury or even death.

At least one technical coordinator accompanies the participant(s) and host(s) during or after the simulated terrorist or other attack, and operates at least one transceiver comprising a camera and audio recording device. The captured/recorded video and audio is sent to a production facility where a computer running software is used to edit the video and audio content for broadcast and optimal viewing quality, and to run in an allotted time period. The show can then be broadcast as a television show, a television series, an internet show, a podcast or other medium.

The third variation of the show is similar to the second variation, except in the third variation instead of a terrorist or other attack, the vulnerability situation consists of a natural or man-made disaster. Some examples of these disasters include an earthquake, a fire, a tornado, a hurricane, a flood, a structure collapse or any other disaster that could occur often with little or no warning.

As far as the production of the third variation of the show, the premise is essentially the same as the second variation. The participant(s) experience a simulated natural or man-made disaster, either while the disaster is occurring or afterwards. The host(s) watches how the participant(s) deal with the disaster and the host(s) comments on any judges the participants actions. The host(s) then offer suggestions and advice on what the participant(s) may have done wrong, or not done, and what actions could be taken to mitigate the danger and possibly prevent injury or death. As with the other variations, at least one technical coordinate or accompanies the participant(s) and host(s) and operates the camera and audio recording device. The video and audio is sent to a production facility for editing in preparation for broadcast.

The third variation of the show could be just as effective as a form of entertainment and to also provide valuable education and skills that both the participant(s) and the viewing audience could possibly benefit from if ever dealing with a disaster in the future.

In view of the above disclosure the primary object of the invention is to produce a method for conducting a vulnerability show that could both entertain and educate participants and audience members on how to react when dealing with a terrorist or other attack or natural or man-made disaster.

It is also an object of the invention to produce a method for conducting a vulnerability show that:
can be used by individuals, couples and families.
can be produced without a significant investment
allow for participants and hosts to obtain free advertising,
allows various anti-terrorism and emergency products to be featured and the benefits of using certain products to be shown,
can product revenue from multiple sources,
dues not require a large operating budget, and
is easy to direct and produce.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a block diagram showing a fire variation of a method for conducting a vulnerability show, with an emphasis on a terrorist attack.

FIG. 2 is a block diagram showing a second variations of a method for conducting a vulnerability show, with an emphasis on a natural or man-made disaster.

### BEST MODE FOR CARRYING OUT THE INVENTION

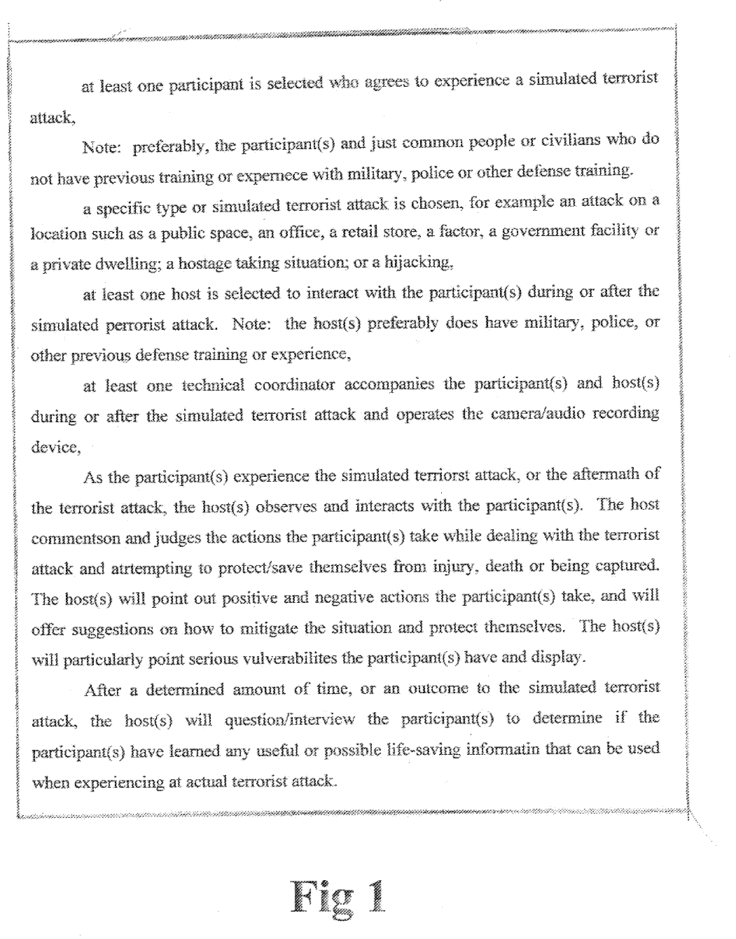

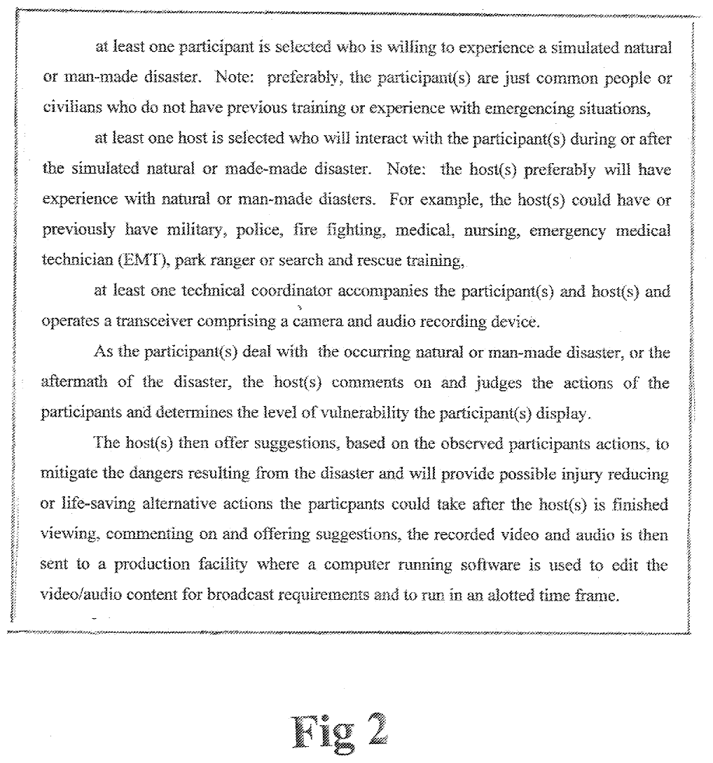

The best mode for carrying out the invention is presented in terms that disclose a preferred embodiment, with three variations of a method for conducting a vulnerability show. One of the most popular types of broadcast entertainment are television and other broadcast shows. Typically, these shows feature a person or persons who is starring in a dramatic, comedic or other structured show, or a person or persons competing in a specific skill or goal, such as singing or losing weight, or will use “hidden” cameras showing a group of people in a certain situation, such as various people living together in a share environment. While these shows are often entertaining, a drama or other type of show could also be utilized to provide education and possible life saving skills in addition to the entertainment. The method for conducting a vulnerability show 10 (show 10), as shown in FIGS. 1 and 2, accomplishes this exact goal.

The show 10 is disclosed herein with three variations, although other variations and modifications could be easily implemented. Thre first variation of the show 10 is preferably along the lines of a television show or series, or other single or episodic show, and is comprised of at least one protagonist who is played by an actor. The actor can simply be chosen for their acting ability, or the actor can have acting ability as well as experience or training in military, law enforcement or government defense. It should be noted, if the show is produced as a purely fictional drama, the protagonist does not need to have any specialized experience or training, other than being trained as an actor who can appear to be an individual with a highly specialized, military, law enforcement or government defense skill-set.

There is also at least one camera and audio recording device for capturing video and audio that is sent to a production facility. The camera and audio recording device(s) are operated by at least one technical coordinator. Depending on the complexity of the written show, additional production persons may also be required such as a director, lighting personnel, set designers, assistants and others.

At the production facility the captured video and audio is processed by a computer running software that processes the video and audio for broadcast on a viewing medium. The entertainment and educational benefits of the show are derived from the at least one protagonist going to a predetermined location such as a public space, an office, a store, a factory, a government facility or a private dwelling where the protagonist(s) comments on and judges the location to discover/determine deficiencies that could place the inhabitants of the location, or the location itself vulnerable to a terrorist or other attack, or natural or man-made disaster. Preferably, the protagonist will be well aware of the skill-set they possess and even though their “job” might appear distasteful to certain people, the objectives the protagonist carries out are essentially good for civilians and the country and while it would be easy for the protagonist to become cynical and jaded, the protagonist must remember and point out the positive impact he or she could have. So, optimally, the protagonist is a likeable character, which will contribute to the show's success.

The second variation of the show is comprised of at least one participant who experiences, a simulated terrorist attack, other type of attack, or other exposure that results in vulnerability, for example a cyber attack or corporate espionage. There is at least one host who interacts with the at least one participant during the simulated terrorist or other attack, or exposure. At least one participant transceiver receives and transmits video and audio content to a production facility, at least one host transceiver also receives and transmits video and audio content to a production facility. At least one technical coordinator accompanies the participant(s) and host(s) and operates the transceivers which comprise a camera and an audio recording device. A computer running software processes the contents from the participant(s) and host(s) for broadcast on a viewing medium.

The method the show 10 is conducted, as shown in FIG. 1, is by the following steps:
at least one participant is selected who agrees to experience a simulated terrorist or other attack.

Note: preferably, the participant(s) and just common people or civilians who do not have previous training or experience with military, police or other defense training.
a specific type or simulated terrorist or other attack, or exposure is chosen, for example an attack on a location such as a public space, an office, a retail store, a factory, a hotel/motel, a transportation means such as an airplane or train, a government facility or a private dwelling; a hostage taking situation; or a hijacking,
at least one host is selected to interact with the participant(s) during or after the simulated terrorist attack. Note: the host(s) preferably does have military, police, or other previous defense training or experience,
at least one technical coordinator accompanies the participant(s) and host(s) during or after the simulated terrorist or other attack and operates the camera/audio recording device.

As the participant(s) experience the simulated terrorist or other attack, or the aftermath of the terrorist or other attack, the host(s) observes and interacts with the participant(s). The host comments on and judges the actions the participant(s) take while dealing with the terrorist attack and attempting to protect/save themselves from injury, death or being captured. The host(s) will point out positive and negative actions the participant(s) take, and will offer suggestions on how to mitigate the situation and protect themselves. The host(s) will particularly point serious vulnerabilities the participant(s) have and display.

After a determined amount of time, or an outcome to the simulated terrorist attack, the host(s) will question/interview the participant(s) to determine if the participant(s) have learned any useful or possible life-saving information that can be used when experiencing at actual terrorist attack.

The third variation of the show 10 is similar to the second variation and is comprised of:
at least one participant who agrees to be on the show,
at least one host who comments on and judges the participant(s),
at least one transceiver for receiving and transmitting audio and visual content to a production facility,
at least one technical coordinator who operates the transceivers, and
a computer opening software that process the contents from the at least one participant and the at least one host for broadcast on a viewing medium.

The major difference between the second variation and the third variation is that in the third variation the participant(s) and host(s) do not interact during or after a simulated terrorist or other attack. Rather, the participant(s) and host(s) interact during or after a simulated natural or man-made disaster, such as an earthquake, a fire, a tornado, a hurricane, a flood a structure collapse, a dangerous material leak, a nuclear accident, an explosion or a vehicle accident. These are just examples, as the show 10 can utilize any other natural or man-made disaster with equal efficacy. Regardless of the type of disaster, the participant(s) will deal with and mitigate the situation and attempt to protect themselves from injury or life threatening results. The host(s) will comment on and judge the actions the participant(s) take and will offer suggestions on how to best deal with the situational experience.

The method the show is conducted for the second variation, as shown in FIG. 2, is by the following steps:
at least one participant is selected who is willing to experience a simulated natural or man-made disaster. Note: preferably, the participant(s) are just common people or civilians who do not have previous training or experience with emergencing situations,
at least one host is selected who will interact with the participant(s) during or after the simulated natural or made-made disaster. Note: the host(s) preferably will have experience with natural or man-made disasters. For example, the host(s) could have or previously have military, police, fire fighting, medical, nursing, emergency medical technician (EMT), park ranger or search and rescue training,
at least one technical coordinator accompanies the participant(s) and host(s) and operates a transceiver comprising a camera and audio recording device.

As the participant(s) deal with the occurring natural or man-made disaster, or the aftermath of the disaster, the host(s) comments on and judges the actions of the participants and determines the level of vulnerability the participant(s) display.

The host(s) then offer suggestions, based on the observed participants actions, to mitigate the dangers resulting from the disaster and will provide possible injury reducing or life-saving alternative actions the participants could take after the host(s) is finished viewing, commenting on and offering suggestions, the recorded video and audio is then sent to a production facility where a computer running software is used to edit the video/audio content for broadcast requirements and to run in at allotted time frame.

It is important to note that since certain variations the show are designed as a show, while the participant(s) are receiving valuable injury protecting and possible life-saving suggestions and information, the viewing audience is also seeing and potentially benefitting from the information/knowledge the participant(s) are receiving. In addition to being only a source of entertainment, the show 10 could be educational and provide a significant amount of valuable information that could be utilized by any person who experiences a terrorist or other attack, or natural or man-made disaster.

Also, for any of the variations, the show 10 could include a panel having at least two individuals who each have experience or training in military, law enforcement or government defense. The individuals comment and judge the actions of the protagonist for variation one, or the participants for variations two and three, during or after the protagonist has visited a location, or the participants during or after a simulated terrorist or other attack, or natural or man-made disaster. If desired, a viewing audience could interact with the individuals on the panel. At least one member of the viewing audience would win a reward based on the metrics of the show and the contribution(s) of the member of the viewing audience.

Also, the show is designed to be broadcast, as previously disclosed, but it would also be possible to release the show in real-time to a live studio audience. Additionally, the show could potentially be produced during an actual terrorist attack, other attack, or other form of exposure that results in vulnerability. Of course, a show such as this would have certain problems or issues that would have to be addressed, but it would be possible. This would definity increase the perceived un-predictability of the events which would add to the realism as well as the entertainment and educational aspects of the show. Also, it should be noted, that either the first terrorist or other attack variation or the second disaster variation would likely require the use of actors, props and set design to create the simulated terrorist or other attack or disaster. Depending on the specifics of each variation, the type and number of actors and props, as well as set design, will be determined based on the requirements of the terrorist or other attack or disaster

While the invention has been described in detail and pictorially shown in the accompanying drawings it is not to be limited to such details, since many changes and modifications may be made to the invention without departing from the spirit and the scope thereof. Hence, it is described to cover any and all modifications and forms which may come within the language and scope of the claims.

1. A method for conducting a vulnerability show comprising:
selecting at least one protagonist who has or acts to have experience or training that is selected from the group consisting of acting, military service, law enforcement and government defense, selecting a location that is from a group consisting of a public space, an office, a store, a factory, a government facility, and a private dwelling,
sending the protagonist to the location to comment on and judge the location for deficiencies that place the inhabitants of the location, or the location itself, in a situation that is vulnerable to a terrorist, or other attack, or natural or man-made disaster,
capturing, by at least one technical coordinator, video and audio of the protagonist,
sending the video and audio of the protagonist to a production facility, and
processing by computer software, the captured video and audio for broadcast on a viewing medium.

2. The method for conducting a vulnerability show of claim 1, further comprising processing and manipulating, by the software, the captured video and audio for optimum viewing quality and editing the video and audio for broadcast and to run in an allotted time period.

3. The method for conducting a vulnerability show of claim 1, wherein the viewing medium is selected from the group consisting of a television show, a television series, a feature film, a video game, a live theatrical production, an internet show, a podcast and a recorded digital medium that is played back on a dedicated playing device.

4. The method for conducting a vulnerability show of claim 1, further comprising commenting on and judging by a panel comprising at least two individuals, the comments and judgements made by the at least one protagonist.

5. A method for conducting a vulnerability show, comprising:
selecting at least one participant who experiences a simulated terrorist or other attack or form of exposure
selecting at least one host who interacts with the at least one participant before, during or after the simulated attack,
receiving and transmitting video and audio content, by at least one host transceiver from/to a production facility,
receiving and transmitting video and audio content, by at least one participant transceiver to a production facility,
selecting at least one technical coordinator who operates the transceivers, and
processing, by computer software, the content from the at least one participant and the at least one host for broadcast on a viewing medium, with the host commenting on and judging preparedness and actions of the at least one participant related to the simulated attack.

6. The method for conducting a vulnerability show of claim 5, wherein the simulated attack comprises an attack on a location that is selected from the group consisting of a public space, an office, a retail store, a factory, a government facility, and a private dwelling.

7. The method for conducting a vulnerability show of claim 5, wherein the at least one host has military, law enforcement or other previous defense training or experience.

8. The method for conducting a vulnerability show of claim 5, wherein the computer software is configured to:
manipulates the video and audio for optimum viewing quality and edit the content for broadcast and to run in an alotted time period.

9. The method for conducting a vulnerability show of claim 5, wherein the viewing medium is selected from the group consisting of a television show, a television series, a feature film, a video game, a live theatrical production recording device, an internet show, a podcast and a recorded digital medium that is played back on a dedicated playing device.

10. The method for conducting a vulnerability show of claim 5, further comprising the at least one participant and at least one host interacting with a live audience.

11. The method for conducting a vulnerability show of claim 5, further comprising selecting a panel comprised of at least two individuals who each have experience or training selected from the group consisting of military, law enforcement and government defense, wherein the at least two individuals comment on and judge the actions of the participants during or ater the simulated terrorist or other attack, or form of exposure.

12. The method for conducting a vulnerability show of claim 12, further comprising providing a viewing audience of members that interacts with the panel of individuals, wherein at least one member of the viewing audience wins a reward based on the metrics of the show and a contribution of die member of the viewing audience.

13. The method for conducting a vulnerability show of claim 5, wherein the simulated attack or form of exposure that results in vulnerability comprises an actual attack or form of exposure.

14. A method for conducting a vulnerability show comprising:
selecting at least one participant who experiences a simulated natural or man-made disaster,
selecting at least one host who interacts with the at least one participant during or after the simulated natural or man-made disaster,
receiving and transmitting by a participant transceiver, video and audio content to a production facility,
receiving and transmitting, by a host transceiver, video and audio content to the production facility,
selecting at least one technical coordinator who operates the transceivers, and
processing the content from the at least one participant and the at least one host for broadcast on a viewing medium, with the host commenting on and judging the preparedness and actions of the at least one participant during the simulated natural or man-made disaster.

15. The method for conducting a vulnerability show of claim 14, wherein the simulated natural or man-made disaster is selected from the group consisting of an earthquake, a fire, a tornado, a hurricane, a flood, a structure collapse, a dangerous material leak, an nuclear accident, an explosion, and a vehicle accident.

16. The method for conducting a vulnerability show of claim 14, wherein the at least one host has experience selected from the group consisting of military, police, fire fighting, bodyguard, medical, nursing, emergency medical technician, park ranger and search and rescue.

17. The method for conducting a vulnerability show of claim 14, wherein the processing content comprises manipulating the video and audio for optimum viewing quality and editing the content for broadcast and to run in an alotted time period.

18. The method for conducting a vulnerability show of claim 14, wherein the viewing medium is selected from a group consisting of a television show, a television series, a feature film, a video game, a live theatrical production, an internet show, a podcast and a recorded digital medium that is played back on a dedicated playing device.

19. The method for conducting a vulnerability show of claim 14, further comprising the at least one participant and at least one host interacting with a live audience.

20. The method for conducting a vulnerability show of claim 14, further comprising selecting a panel comprised of at least two individuals who each have experience or training selected from the group consisting of military, law enforcement and government defense, wherein the individuals comment on and judge the actions of the participants during or after a simulated natural or man-made disaster.

21. The method for conducting a vulnerability show of claim 20, further comprising providing a viewing audience of members, that interacts with the panel of individuals, wherein at least one member of the viewing audience wins a reward based on the metrics of the show and a contribution of the member of the viewing audience.
